(19) United States
(12) Patent Application Publication
(10) Pub. No.: US 2004/0129529 A1
(43) Pub. Date: Jul. 8, 2004

(54) Metal bezel for validator

(76) Inventors: Leon Saltsov, Thornhill (CA); Sergiy Bukhman, Toronto (CA); Sergiy Androsyuk, Toronto (CA); Oleksandr Soyfer, Vinnitsa (UA)

Correspondence Address: DENNISON ASSOCIATES, 133 RICHMOND STREET WEST, SUITE 301, TORONTO, ON, M5H 2L7, CA

(21) Appl. No.: 10/691,487

(22) Filed: Oct. 24, 2003

(30) Foreign Application Priority Data
Dec. 11, 2002 (CA) 2,414,424

(51) Int. Cl. G07F 9/10

(52) U.S. Cl. 194/350

(57) ABSTRACT

A metal bezel with replaceable inserts allows for operation of a validator in one of two orientations. The metal inserts of the bezel provide an upwardly angled banknote feed path having two opposite transitions to reduce the possibility of coins being jammed in the pathway. Preferably, the metal bezel includes its own sensor and drive arrangement for moving of a banknote through the bezel to the drive of the validator.

### BACKGROUND OF THE INVENTION

Banknote validators are now commonly used for a host of different vending, gaming and entertainment machines. The user inserts banknotes into the validator which determines the authenticity thereof and provides credit with respect to a particular associated machine. Many vending, gaming and entertainment type devices are in an unattended location and can be subject to vandalism.

A banknote validator typically has a bezel which projects out of the machine and allows the user to feed a banknote through an entry slot. The banknote is sensed by the validator and advanced through the validator. The bezels are typically made of plastic, however, they can also be made of metal.

The banknote slot associated with a validator provides a banknote guide path for aligning of a banknote as a user inserts a banknote into the validator. The validator senses the end of the banknote and activates a drive arrangement to pull the banknote into the validator for processing.

The validator is basically interior to the vending machine, however, the projecting bezel is subject to vandalism. It is also known to try to lodge coins in the banknote slot or to pour liquids into the bezel in an attempt to contaminate the drive components associated with the validator. To overcome this last problem, the banknote slot is typically angled upwardly whereby gravity allows draining of this material from the slot.

Validators are primarily designed to operate in one orientation, however, depending upon the machine in which they are to be installed, the validator can be mountable in either a stacker up or stacker down orientation. Basically, the banknote after passing through the validator, is either fed vertically upwardly towards a stacker or is fed downwardly towards a stacker or other device.

A metal vandal proof or vandal resistant bezel designed for a stacker down orientation of the validator head, when reversed to a stacker up position, unfortunately reverses the slope of the banknote slot. The banknote slot which was previously upwardly angled, now is downwardly angled. Unfortunately, this can render the validator prone to liquid contamination. For this reason, a different bezel is typically used for the stacker up and the stacker down orientation which are specific to those orientations.

From a manufacturing point of view, this is not desirable as different components are necessary for a stacker up and stacker down orientation and the exact orientation of the validator is often not known until it is to be installed in a particular device.

### SUMMARY OF THE INVENTION

A metal bezel for a banknote validator according to the present invention comprises a main housing, a banknote driver arrangement secured in said main housing, and an insert received in a port of the housing. The insert defines a curved banknote slot leading to the banknote drive arrangement secured in the housing. The curved banknote slot has a narrow entry which is connected by a first transition to an upwardly angled section which is connected to a second transition leading to the banknote drive arrangement. The first and second transitions and said upwardly angled section act as a guide for push insertion of a leading portion of the banknote into the validator while minimizing the possibility of lodging of a coin in the banknote slot. The transitions of the banknote slot prevent a coin being moved through this portion to the banknote drive arrangement.

According to an aspect of the invention, the insert is a two piece assembly which defines the banknote guide between the two components thereof.

In yet a further aspect of the invention, said port extends substantially across the housing and is adjacent one of a top edge or bottom edge of the housing.

In yet a further aspect of the invention, the insert cooperates with the housing to provide an area of high strength about the banknote guide.

In yet a further aspect of the invention, the insert is selected from a first insert design for a stacker up orientation of a validator and a second insert which is designed for a stacker down orientation of a validator.

Either the first insert or the second insert may be secured within the housing depending upon the particular orientation of the validator to be used.

### BRIEF DESCRIPTION OF THE DRAWINGS

Preferred embodiments of the invention are shown in the drawings, wherein:

FIG. 1 is a partial sectional view through the metal bezel when attached to a validator;

FIG. 2 is an exploded perspective view showing various components of the metal bezel;

FIG. 3 is an exploded perspective view of the metal bezel of FIG. 2 showing the opposite surfaces thereof;

FIG. 4 is an exploded perspective view of the metal bezel orientated for a stacker up orientation of the validator;

FIG. 5 is a rear exploded perspective view of the metal bezel of FIG. 4;

FIG. 6 is a partial sectional view of the metal bezel within an insert for a stacker up orientation of the validator; and

FIG. 7 is a partial sectional view of the metal bezel with an insert for a stacker down orientation of the validator.

### DETAILED DESCRIPTION OF THE PREFERRED EMBODIMENTS

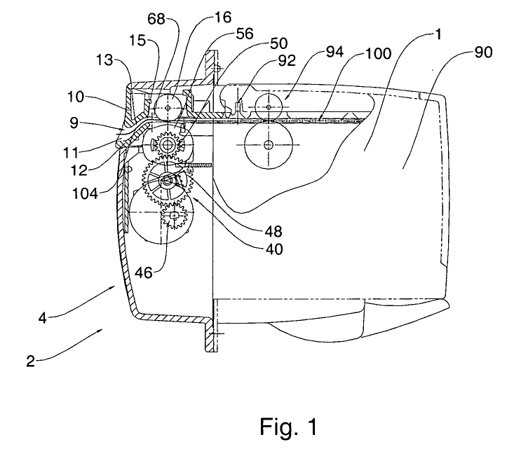

The metal bezel 2 shown in FIG. 1 is attached to a banknote validator 90. This validator includes its own banknote pathway 100 for moving of the banknote past a number of sensors and making an evaluation with respect to the authenticity of the banknote. If the banknote is accepted, it typically passes through the validator and is stored in a stacker device or a hopper. The machine associated with the validator is then provided or notified of the appropriate credit. If the banknote is determined not to be authentic, it is returned through the banknote pathway to the user.

In many cases, a validator 90 only requires a plastic bezel having an appropriate slot for feeding of a banknote into the validator to be sensed by the sensor 92. The sensor activates the device and moves the banknote through the validator. In standalone applications where vandalism may be a problem, the metal bezel 2 is attached in front of the validator and includes its own drive arrangement 40. A banknote 104 is pushed through the banknote slot 9 by the user and this banknote slot has an angled pathway with two transitions designed to reduce the possibility of coins being jammed in the pathway.

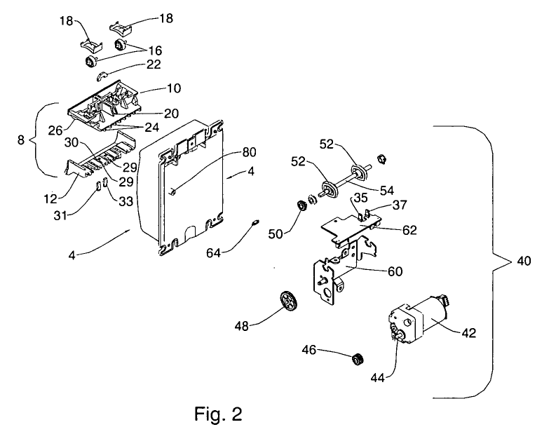

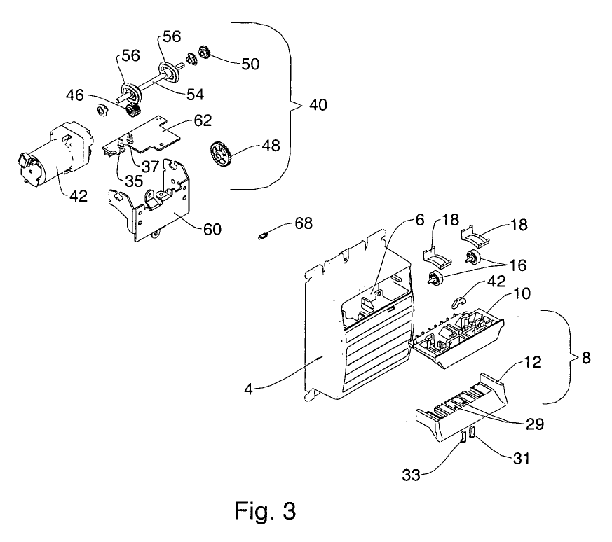

The metal bezel 2, as shown in FIG. 1 and the two exploded perspective views of FIGS. 2 and 3, has a main housing 4 attached to the validator 90 in the conventional manner. The main housing has a large port 6 extending across the housing at a top or bottom edge thereof which receives a metal insert 8. The metal insert 8 has a first component 10 and a second component 12 which define the banknote receiving slot 9. This slot 9 has an initial curved transition connecting to a short straight section followed by a reverse transition to position an inserted banknote generally adjacent the idler roller 16. The banknote is sensed at this point and the drive arrangement 40 of the metal bezel is activated and the banknote is advanced to the validator 90.

As shown in FIG. 1, the insert defines a banknote guide having a first transition 11 connected to the straight segment 13 which is connected to a reverse transition 15. The banknote 104, due to its structural characteristics, can be push inserted through this arrangement and is sensed by the sensor 68. This causes the drive arrangement 40 to be activated with the eventual rotation of drive shaft 54 associated with the oval drive rollers 56. The oval drive rollers 56 are normally in a clear position and when a banknote is sensed, they are rotated to engage a banknote, advance it into the validator, and thereafter return to a clear position. In this way, the validator can advance the banknote without further cooperation with the drive of the bezel.

Returning to the exploded perspective views of FIGS. 2 and 3, idler rollers 16 are mounted in slots of the first component 10 and have spring bias member 18 thereabove. These spring bias members include locking tabs which engage locking slots in the first component 10 to maintain the idler rollers in the component 10. The insert 10 also includes a double reflecting light guide 32 which again is retained in a slot. This light guide has the ends thereof exposed on the lower surface of component 10.

The second component 12 has two openings 29 on an upper surface of the member which receive a light guide 31 and a light guide 33. These light guides cooperate with the light source 35 provided on the printed circuit board 62 and the light receiver 37. In this way, a beam of light is transmitted across the banknote pathway, is reflected by the double reflecting light guide 32, and returned across the pathway to light guide 33 and the receiver 37. With this arrangement, if the banknote is not present between the components 10 and 12, the drive arrangement remains idle. If a banknote is inserted into the bezel, the leading edge of the banknote is sensed and the motor 41 is activated. This results in rotation of drive shaft 44 of the motor and driving of gears 46, 48 and 50 to effect rotation of the oval drive rollers 56. The motor 42, the printed circuit board 62 and the drive shaft 54 are all secured within the main housing 4 by means of a mounting bracket 60. The mounting bracket 60 as shown in FIG. 1 is mechanically secured to the securing lug 80 of the main housing 4.

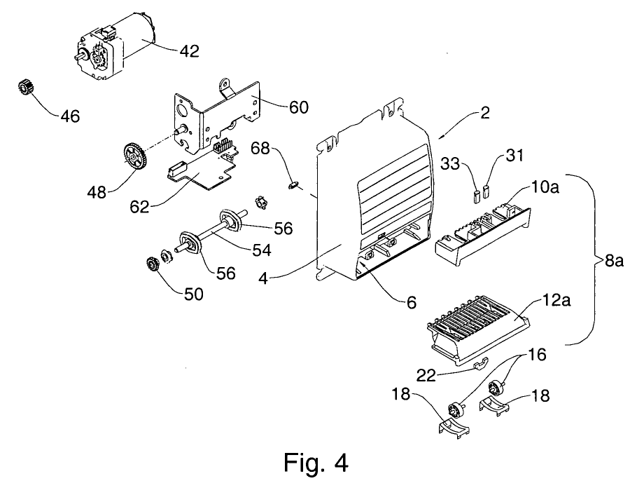

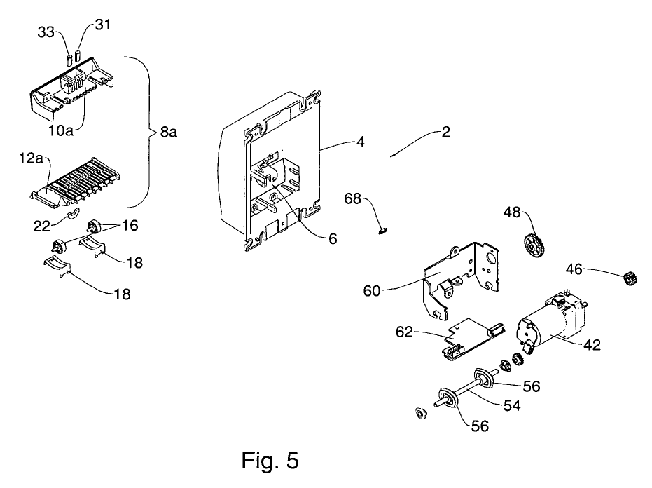

FIGS. 4, 5 and 6 again show the metal bezel 2 in the main housing 4 with a different insert 8a. The insert 8a has a first component 10a and a second component 12a. These inserts are mechanically secured in the port 6 from the inside of the main housing 4 and are designed to accommodate the opposite orientation of a validator 90.

The orientation of the housing reflective to the validator is the same. The drive components within the metal bezel remain the same. The entry to the conventional validator remains the same. Each of the inserts is of a height to overlap with the idler roller and the oval drive rollers. This allows the required reversal in direction of the pathway to the validator as required by the validator stacker up or stacker down orientation.

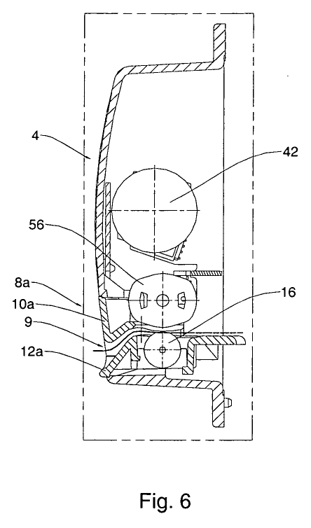

A shown in the sectional view of FIG. 6, the banknote pathway is now angled upwardly although the slot is provided at the bottom edge. The main housing 4 has been rotated about a horizontal axis of 180 degrees. In this way the main housing 4 can be used either for a stacker up orientation of a validator or a stacker down orientation of a validator and the components of the metal bezel, other than the insert, are common for both orientations. This simplifies the manufacture of the device.

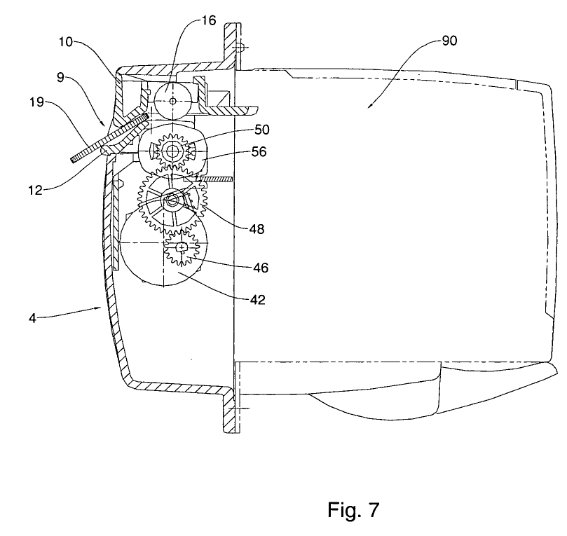

The metal bezel 2 and in particular the inserts for the metal bezel, cooperate to define a rapidly changing banknote path where a banknote has a suitable pathway leading to the validator, however, a coin 19 or other object as shown in FIG. 7 cannot become lodged in this curved transition. Furthermore the inserts are designed such that the pathway to the drive arrangement of the metal bezel is downwardly angled whereby any fluid inserted into this pathway tends to drain. This angled pathway of the inserts project to the validator as well as the drive components and sensor of the bezel.

The motor 42 is electrically connected by a suitable harness to the control of the validator 90. The drive of the motor 42 is preferably coordinated with the validator and once a banknote has been fed and received by the validator, the drive arrangement 40 will return to a clear position of the oval rollers 56. This is desirable as it allows for movement of the banknote to allow further aligning of the banknote in the validator. The separate drive arrangement 44 of the metal bezel is desirable in that it provides a simple means for advancing of a banknote to the validator which may be necessary due to the quickly changing direction of the transition path of the banknote through the inserts to the pathway of the validator. Worn banknotes are not a stiff as new banknotes and problems can occur in feeding of a worn banknote into a validator. This problem is further compounded if the banknote is rejected and has passed through the metal bezel into the validator. The drive arrangement 40, when the validator has determined the banknote should be rejected, is activated and rotates at the same speed or slightly higher speed relative to the drive of the validator. Therefore, as the banknote is being returned through the validator and through the metal bezel to the user, the oval rollers 56 will strike it from time to time and assist in moving of the former back edge of the banknote through the bezel insert and return it to the user without jamming.

As can be appreciated, the purpose of the metal bezel is to avoid vandalism, however, this would not be a satisfactory arrangement if it rendered the system more prone to jamming. If a banknote becomes jammed in the system then a service technician or is required to clear the device and a customer may be upset. The separate intermittent drive for the metal bezel provides positive feeding of a banknote into the validator as well as positive return of the banknote to the user should it be rejected.

Although various preferred embodiments of the present invention have been described herein in detail, it will be appreciated by those skilled in the art, that variations may be made thereto without departing from the spirit of the invention or the scope of the appended claims.

The embodiments of the invention in which an exclusive property or privilege is claimed are defined as follows:

1. A metal bezel for a banknote validator, said metal bezel comprising a main housing, a banknote drive arrangement secured in said main housing and an insert received in a port of said housing and defining a curved banknote slot leading to said banknote drive arrangement secured in said main housing, said curved banknote slot having a narrow entry which is connected by a first curved transition to an upwardly angled section which is connected to by a second curved transition leading to the banknote drive arrangement, said first and second curved transitions and said upwardly angled section allowing push insertion of a leading portion banknote therethrough by a user while minimizing the possibility of lodging of a coin in said curved banknote slot.

2. A metal bezel as claimed in claim 1 wherein said insert is a two piece assembly which defines said curved banknote slot between said two pieces thereof.

3. A metal bezel as claimed in claim 1 wherein said port extends substantially across said housing and is adjacent one of a top edge or a bottom edge of said housing.

4. A metal bezel as claimed in claim 1 wherein said insert and said housing cooperate to provide an area of high strength about said curved banknote slot.

5. A metal bezel as claimed in claim 4 wherein said main housing and said insert are made by metal casting.

6. A metal bezel as claimed in claim 1 wherein said insert is one of a first insert and a second insert, said first insert being used for a stacker up orientation of a validator and said second insert being used for a stacker down orientation of a validator.
